(19) United States
(12) Patent Application Publication
(10) Pub. No.: US 2004/0043050 A1
(43) Pub. Date: Mar. 4, 2004

(54) Bot remover

(76) Inventor: Christopher Robert Paulson, Okeechobee, FL (US)

Correspondence Address: Christopher Paulson, 2386 SE 27th St., Okeechobee, FL, 34974, US

(21) Appl. No.: 10/232,235

(22) Filed: Sep. 3, 2002

(51) Int. Cl. A01N 25/00

(52) U.S. Cl. 424/405; 424/94.61

(57) ABSTRACT

The purpose of the “The Bot Remover” is to remove the bot egg with little effort and less time for the horse owners to put forth. The reason why the solution works better than anything else on the market is because the egg is held on by starch and the amylase dissolves the starch by catalyzing the hydrolysis of the starch which changes it into a more simpler carbohydrates. The reason why the solution is warmed to thirty-eight to forty-five degrees Celsius is because the amylase works the best at body temperature.

First pour one thousand milliliters of tap water into a one thousand milliliter beaker. Put the one thousand milliliters beaker onto the hot plate and turn it onto high. Then measure approximately 0.010 grams of alpha amylase with an electronic balance. Transfer the alpha amylase into the one thousand milliliters beaker and stir solution with a magnetic stirrer. To do this, turn the stir knob on the hot plate just below high. Get one hundred milliliters graduated cylinder, pour five milliners of ammonia into the one hundred milliliters graduated cylinder. Transfer the ammonia from the graduated cylinder to the one thousand milliliters beaker. Then get a litmus pH paper to make sure that the solution is at a pH of ten, if it is not put one milliliter of ammonia into the solution. Meanwhile the magnet stirrer is still stirring to mix the solution. Check the temperature to make sure that the solution is in between thirty-eight to forty-five degrees Celsius. Once the temperature is at the required temperature, put it into a thermos so the temperature can remain relatively constant.

### BACKGROUND INFORMATION

This product pertains to horse industry or agricultural field because the product removes hot fly's eggs from the horse's flank. The reason why this product works is because the egg is held on by starch. This product dissolves the starch; therefore, allowing the egg to come off the hair. This is why the product works so well in reducing the time and effort the horse owners have to put forth in order to get the eggs off the horse's flank.

### SUMMARY OF INVENTION

The general idea of this product is to reduce the time and effort that the horse owners have to put forth in order to get rid of the hot fly's eggs. The advantage of this product is that it takes less time for the horse owners to remove the bot fly's eggs off the horse's flanks. This in turn allow the horse owners to put forth less effort to remove the eggs because the amylase loosens the eggs from the horse's flank; therefore, the horse owner will not have to scrub as hard to get the eggs off the horse's flank. Since the horse owners are spending less time trying to remove the bot eggs from the horse's flank, they have more leisure time.

### DETAILED DESCRIPTION OF THE INVENTION

First pour one thousand milliliters of tap water into a one thousand milliliter beaker. Put the one thousand milliliters beaker onto the hot plate and turn it onto high. Then measure approximately 0.010 grams of alpha amylase with an electronic balance. Transfer the alpha amylase into the one thousand milliliters beaker and stir solution with a magnetic stirrer. To do this, turn the stir knob on the hot plate just below high. Get one hundred milliliters graduated cylinder, pour five milliners of ammonia into the one hundred milliliters graduated cylinder. Transfer the ammonia from the graduated cylinder to the one thousand milliliters beaker. Then get a litmus pH paper to make sure that the solution is at a pH of ten, if it is not put one milliliter of ammonia into the solution. Meanwhile the magnet stirrer is still stirring to mix the solution. Check the temperature to make sure that the solution is in between thirty-eight to forty-five degrees Celsius. Once the temperature is at the required temperature, put it into a thermos so the temperature can remain relatively constant.

First the solution needs to be removed from the thermos and poured into a spray bottle. Then spray the area that is infected with the bot fly's egg. Rub your hand down the area that is infected with the bot fly's eggs to smooth the area, so it is easier to remove the bot fly's eggs. Then use a bot block or bot knife to remove the eggs off the horse's flank. Keep scraping the area tat is infected with the eggs until all the eggs are removed.

1. I claim that this product removes the bot fly's eggs off the horse's flank efficiently and requires lest effort for the horse owners.
